(19) United States
(12) Patent Application Publication
(10) Pub. No.: US 2024/0248026 A1
(43) Pub. Date: Jul. 25, 2024

(54) SPECTRAL IMAGE ANALYSIS METHOD, SPECTRAL IMAGE ANALYSIS PROGRAM, AND SPECTRAL IMAGE ANALYSIS DEVICE

(71) Applicant: SEIKO EPSON CORPORATION, TOKYO (JP)

(72) Inventor: Kei KANEMOTO, Fujimi-machi (JP)

(21) Appl. No.: 18/415,717

(22) Filed: Jan. 18, 2024

(30) Foreign Application Priority Data
Jan. 23, 2023 (JP) 2023-007970

(51) Int. Cl. G01N 21/31; G06V 10/143; G06V 10/25; G06V 10/60

(52) U.S. Cl. CPC G01N 21/31; G06V 10/143; G06V 10/25; G06V 10/60

(57) ABSTRACT

A spectral image analysis method includes: acquiring a target image that is an image obtained by imaging a target object and that includes a plurality of spectral images corresponding to a plurality of spectral wavelengths different from one another; calculating, based on a light intensity of a region of the target image divided for each of the plurality of spectral wavelengths, a spectral spectrum for the divided region; calculating a primary differential value and a secondary differential value of the spectral spectrum at a target wavelength that is a known absorption wavelength of a target substance; and detecting the divided region identified as an image region of the target substance from the target image based on the primary differential value and the secondary differential value.

The present application is based on, and claims priority from JP Application Serial Number 2023-007970, filed Jan. 23, 2023, the disclosure of which is hereby incorporated by reference herein in its entirety.

### BACKGROUND

### 1. Technical Field

The present disclosure relates to a spectral image analysis method, a spectral image analysis program, and a spectral image analysis device.

### 2. Related Art

In the related art, there is known a method of analyzing a spectral image obtained by imaging a substance to perform spectral analysis of the substance. For example, Mizuki TSUTA, Tomohiro TAKAO, Junichi SUGIYAMA, Yukihiro WADA, Yasuyuki SAGARA. “Foreign Substance Detection in Blueberry Fruits by Spectral Imaging” Food Science and Technology Research Vol. 12 No. 2, issued by Japan Society for Food Science and Technology, in 2006, published on May 25, 2007, pp. 96-100 (Non-Patent Literature 1) discloses a method of determining foreign substances such as leaves and branches mixed into blueberries by analyzing a spectral image obtained by imaging the blueberries. In the method, a secondary differential absorbance at 680 nm, which is an absorption wavelength of chlorophyll contained in the foreign substances such as leaves and branches, is calculated for each pixel based on an absorption spectrum obtained from the spectral image, and pixels corresponding to the foreign substances are detected based on the secondary differential absorbance.

However, in the spectral image analysis method using a secondary differential value of a spectral spectrum as described in Non-Patent Literature 1 described above, when there are a plurality of substances having absorption wavelengths close to one another, it is difficult to detect one of the substances as a target substance. For example, it is difficult to set a threshold value for detecting a target substance while distinguishing the target substance from other substances because the spectral spectra of the substances having absorption wavelengths close to one another show a relatively large secondary differential value at all absorption wavelengths, and the secondary differential value changes depending on a thickness of an imaged substance material.

### SUMMARY

A spectral image analysis method according to a first aspect of the present disclosure is a spectral image analysis method to be executed by a computer. The method includes: the computer acquiring a target image that is an image obtained by imaging a target object and that includes a plurality of spectral images corresponding to a plurality of spectral wavelengths different from one another; calculating, based on a light intensity of a region of the target image divided for each of the plurality of spectral wavelengths, a spectral spectrum for the divided region; calculating a primary differential value and a secondary differential value of the spectral spectrum at a target wavelength that is a known absorption wavelength of a target substance; and detecting the divided region identified as an image region of the target substance from the target image based on the primary differential value and the secondary differential value.

A non-transitory computer-readable storage medium stores a spectral image analysis program, that is readable and executable by a computer, according to a second aspect of the present disclosure, and the program causes the computer to execute the above-described spectral image analysis method.

A spectral image analysis device according to a third aspect of the present disclosure includes: an image acquisition unit configured to acquire a target image that is an image obtained by imaging a target object and that includes a plurality of spectral images corresponding to a plurality of spectral wavelengths different from one another; a spectrum calculation unit configured to calculate, based on a light intensity of a region of the target image divided for each of the plurality of spectral wavelengths, a spectral spectrum for the divided region; an evaluation value calculation unit configured to calculate a primary differential value and a secondary differential value of the spectral spectrum at a target wavelength that is a known absorption wavelength of a target substance; and a detection unit configured to detect the divided region identified as an image region of the target substance from the target image based on the primary differential value and the secondary differential value.

### BRIEF DESCRIPTION OF THE DRAWINGS

FIG. 1 is a block diagram showing a schematic configuration of a spectral image analysis device according to an embodiment of the present disclosure.

FIG. 2 is a flowchart showing an example of the spectral image analysis method according to the embodiment.

FIG. 3 is a graph showing reflection spectra of a target substance and an approximate substance.

FIG. 4 is a graph showing primary differential waveforms of the reflection spectra of the target substance and the approximate substance.

FIG. 5 is a graph showing secondary differential waveforms of the reflection spectra of the target substance and the approximate substance.

FIG. 6 is a schematic diagram showing an example of a spectral image obtained by the spectral image analysis device.

FIG. 7 is a schematic diagram showing an example of a detection image generated by the spectral image analysis device.

FIG. 8 is a flowchart showing another example of the spectral image analysis method according to the embodiment.

### DESCRIPTION OF EMBODIMENTS

Hereinafter, an embodiment according to the present disclosure will be described.

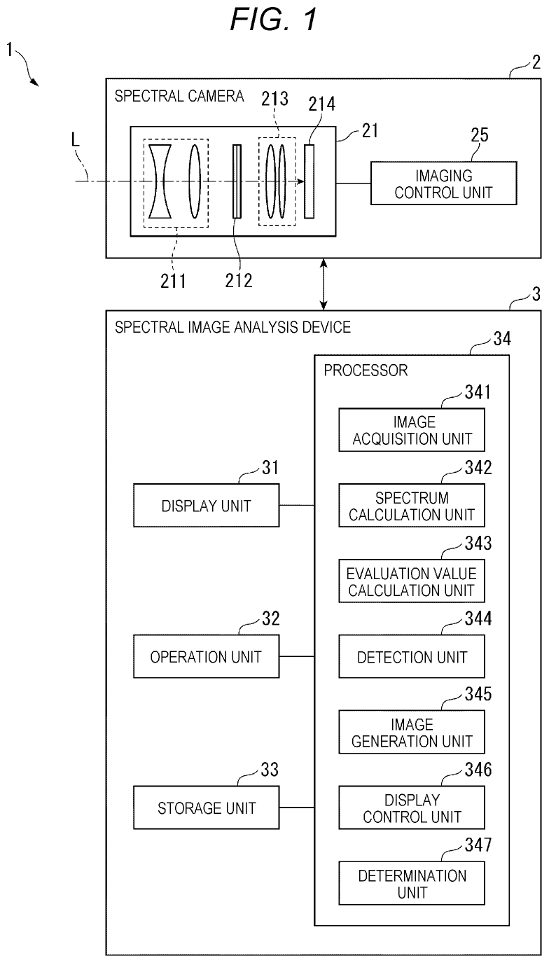

FIG. 1 is a block diagram showing a schematic configuration of a spectral image analysis system 1 according to the embodiment.

As shown in FIG. 1, the spectral image analysis system 1 according to the embodiment includes a spectral camera 2 and a spectral image analysis device 3. In the spectral image analysis system 1, the spectral camera 2 spectrally images a target object at a plurality of spectral wavelengths different from one another. In addition, the spectral image analysis device 3 analyzes a target image including a plurality of spectral images Is imaged by the spectral camera 2, thereby detecting pixels identified as an image region of a target substance from the target image.

### Configuration of Spectral Camera 2

As shown in FIG. 1, the spectral camera 2 includes an imaging unit 21 and an imaging control unit 25. The imaging unit 21 includes an incident optical system 211, a spectral element 212, an image forming optical system 213, and an imaging element 214.

The incident optical system 211 guides measurement light L, which is light reflected by a target object, to the spectral element 212. The incident optical system 211 includes, for example, a plurality of lenses forming an image-side telecentric optical system, and makes a principal ray of the measurement light L parallel and incident on the spectral element 212.

The spectral element 212 is an element that spectrally separates light centered on a desired wavelength among the measurement light L incident from the incident optical system 211, and is an element that can switch a wavelength at which the light can be spectrally separated. For example, a wavelength tunable Fabry-Perot etalon can be used as the spectral element 212. The Fabry-Perot etalon includes a pair of reflective films facing each other and an actuator element that changes a gap size between the pair of reflective films, and can transmit light of a wavelength corresponding to the gap size.

The spectral element 212 may have a configuration that reflects light of a desired spectral wavelength toward the imaging element 214. In addition, the spectral element 212 is not limited to the Fabry-Perot etalon as described above, and may be, for example, an acousto-optic tunable filter (AOTF) or a liquid crystal tunable filter (LCTF).

The image forming optical system 213 includes, for example, a plurality of lenses, and forms, on the imaging element 214, an image of light transmitted through the spectral element 212.

The imaging element 214 receives light centered on a desired spectral wavelength spectrally separated by the spectral element 212, and images the spectral image Is. For example, a general image sensor such as a charge-coupled device (CCD) or a complementary metal-oxide semiconductor (CMOS) can be used as the imaging element 214.

The imaging control unit 25 includes a spectral control circuit that controls the spectral element 212, an imaging control circuit that controls the imaging element 214, a microcomputer that controls an overall operation of the spectral camera 2, a camera memory that stores various kinds of data, and the like.

The spectral control circuit outputs a drive signal to the spectral element 212 under control of the microcomputer to control the spectral wavelength of the spectral element 212.

The imaging control circuit drives the imaging element 214 under the control of the microcomputer. Accordingly, the imaging element 214 images the spectral image Is corresponding to each spectral wavelength of the spectral element 212.

The microcomputer controls the spectral control circuit and the imaging control circuit.

The camera memory records various kinds of data for controlling the spectral control circuit and the imaging control circuit, and the spectral image Is.

### Configuration of Spectral Image Analysis Device 3

The spectral image analysis device 3 is a general computer such as a smartphone, a tablet terminal, or a personal computer, and can communicate with the spectral camera 2 by any communication method. As shown in FIG. 1, the spectral image analysis device 3 includes a display unit 31, an operation unit 32, a storage unit 33, and a processor 34.

The display unit 31 displays the spectral image Is imaged by the spectral camera 2, a detection image Id to be described later, and the like. The display unit 31 may be a general display device such as a liquid crystal display, or may be a head-mounted display device worn on a head of a user. In addition, the display unit 31 may be implemented separately from the spectral image analysis device 3 and may be communicably connected to the spectral image analysis device 3.

The operation unit 32 receives an operation of the user and outputs an operation signal corresponding to the operation to the processor 34. The operation unit 32 may be various input devices such as a mouse and a keyboard, or may be a touch panel integrated with the display unit 31.

The storage unit 33 can record various kinds of data and various programs used by the processor 34. Specifically, the storage unit 33 stores the plurality of spectral images Is obtained from the spectral image analysis device 3, the detection image Id to be described later, a spectral image analysis program for controlling the spectral image analysis device 3, and the like. In addition, the storage unit 33 stores an absorption wavelength corresponding to each substance that is a candidate for the target substance.

The processor 34 functions as an image acquisition unit 341, a spectrum calculation unit 342, an evaluation value calculation unit 343, a detection unit 344, an image generation unit 345, a display control unit 346, and a determination unit 347 by reading and executing the spectral image analysis program stored in the storage unit 33. Details of each function will be described later.

### Spectral Image Analysis Method

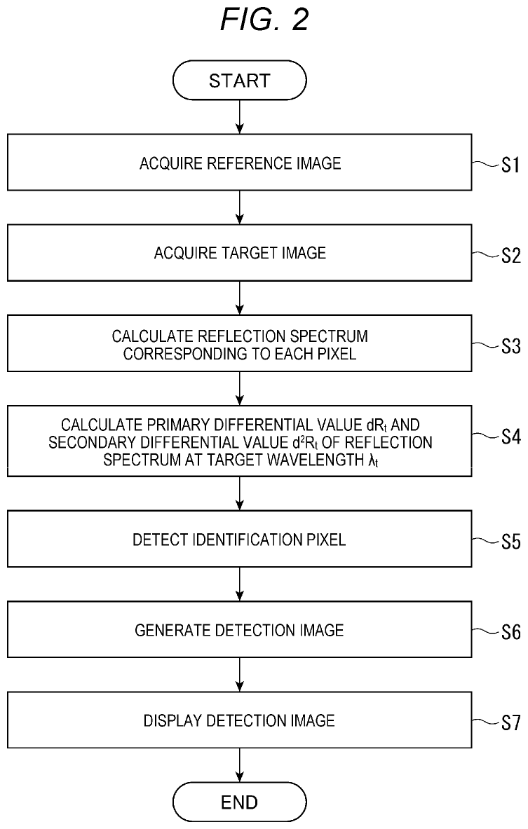

An example of the spectral image analysis method according to the embodiment will be described with reference to a flowchart of FIG. 2.

In the embodiment, an imaging environment such as illumination is set as preparation before start of the flowchart of FIG. 2, and a reference object is disposed over the entire imaging range of the spectral camera 2. The reference object is not particularly limited, and is preferably an object such as a white plate whose reflectance in the imaging range is uniform with respect to the wavelength. In addition, the user also designates a target substance for the spectral image analysis device 3 through the operation unit 32.

The image acquisition unit 341 of the spectral image analysis device 3 outputs a command to perform spectral imaging to the spectral camera 2 in response to a user operation or the like. Accordingly, the spectral camera 2 sequentially switches the spectral wavelengths in the spectral element 212 and performs imaging at each spectral wavelength. In addition, the image acquisition unit 341 acquires a reference image including the plurality of spectral images Is from the spectral camera 2 (step S1).

After step S1, the user excludes the reference object from the imaging range of the spectral camera 2 and arranges one or more target objects in the imaging range. Then, the image acquisition unit 341 of the spectral image analysis device 3 outputs a command to perform the spectral imaging to the spectral camera 2 in response to the user operation or the like. Accordingly, the spectral camera 2 sequentially switches the spectral wavelengths in the spectral element 212 and performs imaging at each spectral wavelength. In addition, the image acquisition unit 341 acquires a target image including the plurality of spectral images Is from the spectral camera 2 (step S2).

In steps S1 and S2 described above, the command that the image acquisition unit 341 outputs to the spectral camera 2 includes wavelength information designating a plurality of spectral wavelengths. The plurality of spectral wavelengths in the embodiment are three wavelengths including a wavelength corresponding to a target substance designated by the user (hereinafter, a target wavelength λt), a forward wavelength λₜ₊ₕ placed in front of the target wavelength λt, and a backward wavelength λₜ₋ₕ placed behind the target wavelength λt.

When the target substance has a plurality of absorption wavelengths, any one of the absorption wavelengths may be set as the target wavelength λt. A wavelength difference h between each of the forward wavelength λₜ₊ₕ and the backward wavelength λₜ₋ₕ and the target wavelength λt may be set to a minute value that enables numerical differentiation to be described later. The wavelength difference h is preferably set based on an S/N ratio of the spectral camera 2 or the like to achieve desired detection accuracy, and is, for example, 50 nm.

Next, the spectrum calculation unit 342 calculates a reflection spectrum corresponding to each pixel of the target image based on the reference image acquired in step S1 and the target image acquired in step S2 (step S3).

Specifically, the spectrum calculation unit 342 calculates, for each spectral wavelength, a reflectance of a pixel (xi,yj) by dividing a light intensity of the pixel (xi,yj) of the target image by a light intensity of the pixel (xi,yj) of the reference image. Accordingly, the reflection spectrum corresponding to the pixel (xi,yj) of the target image is calculated. The spectrum calculation unit 342 according to the embodiment calculates the reflection spectrum corresponding to each pixel for all pixels of the target image.

Next, the evaluation value calculation unit 343 calculates, for each pixel of the target image, a primary differential value dRₜ and a secondary differential value d²Rₜ of the reflection spectrum at the target wavelength λₜ based on the reflection spectrum calculated in step S3 (step S4).

Here, each of the primary differential value dRₜ and the secondary differential value d²Rₜ is an evaluation value for identifying the image region of the target substance. The evaluation value calculation unit 343 according to the embodiment can calculate the primary differential value dRₜ and the secondary differential value d²Rₜ by the numerical differentiation. For example, the evaluation value calculation unit 343 uses central difference approximation to calculate the primary differential value dRₜ by the following formula (1), and calculates the secondary differential value d²Rₜ by the following formula (2).

$$d {R}_{t} = \frac{{R}_{t + h} - {R}_{t - h}}{2 h} \qquad ( 1 )$$

$${d}^{2} {R}_{t} = \frac{{R}_{t + h} - 2 {R}_{t} + {R}_{t - h}}{{h}^{2}} \qquad ( 2 )$$

In formulas (1) and (2), Rₜ is a reflectance at the target wavelength λₜ, Rₜ₊ₕ is a reflectance at the forward wavelength λₜ₊ₕ, and Rₜ₋ₕ is a reflectance at the backward wavelength λₜ₋ₕ.

Next, the detection unit 344 detects a pixel (hereinafter, referred to as an identification pixel) identified as an image region of the target substance from the target image based on the primary differential value dRₜ and the secondary differential value d²Rₜ of each pixel calculated in step S4 (step S5).

Here, in order to describe step S5, the reflection spectra of any target substance and an approximate substance which is a substance other than the target substance and has an absorption wavelength close to the target wavelength λₜ will be described.

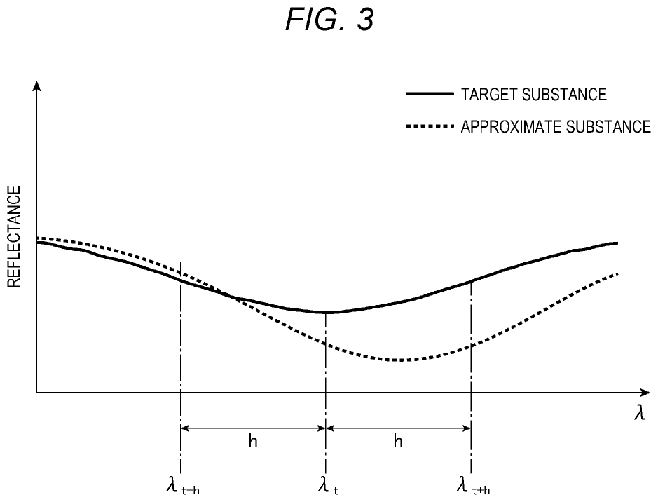

FIG. 3 is a graph showing waveforms of the reflection spectra of the target substance and the approximate substance. As shown in FIG. 3, the reflection spectrum of the target substance indicates a peak at a target wavelength λₜ, and the reflection spectrum of the approximate substance indicates a peak at a wavelength different from the target wavelength λₜ.

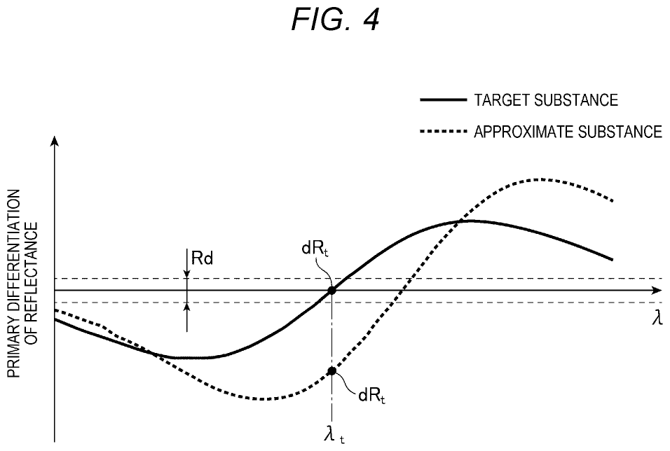

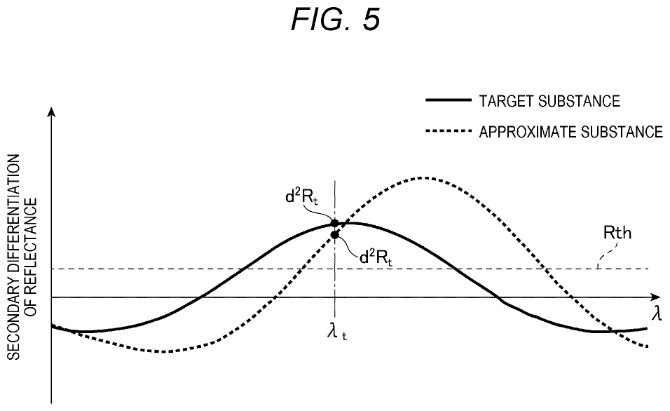

FIG. 4 is a graph showing primary differential waveforms of the reflection spectra of the target substance and the approximate substance, and FIG. 5 is a graph showing secondary differential waveforms of the reflection spectra. As shown in FIG. 4, the primary differential waveform of the reflection spectrum of the target substance indicates 0 at the target wavelength λₜ, while the primary differential waveform of the reflection spectrum of the approximate substance indicates a value greatly deviating from 0 at the target wavelength λₜ. In addition, as shown in FIG. 5, the secondary differential waveform of the reflection spectrum of the target substance indicates a peak at the target wavelength λₜ, while the secondary differential waveform of the reflection spectrum of the approximate substance does not have a peak at the target wavelength λₜ.

Therefore, the target substance can be identified by setting a predetermined detection range Rd including 0 for the primary differential value dRₜ and setting a predetermined threshold value Rth smaller than a peak value of the secondary differential waveform of the target substance for the secondary differential value d²Rₜ.

A width of the detection range Rd is not particularly limited, and is, for example, a range including allowable errors above and below 0. A magnitude of the threshold value Rth is not particularly limited, and is, for example, about half the peak value of the secondary differential waveform of the target substance.

In step S5 described above, the detection unit 344 determines whether the primary differential value dRₜ is within the predetermined detection range Rd and the secondary differential value d²Rₜ is equal to or greater than the predetermined threshold value Rth for each pixel of the target image. Then, the detection unit 344 can detect, as the identification pixel of the target substance, a pixel for which it is determined that the primary differential value dRₜ is within the predetermined detection range Rd and the secondary differential value d²Rₜ is equal to or greater than the predetermined threshold value Rth.

If the approximate substance is present in the target image, the secondary differential value d²Rₜ of the pixel in the image region of the approximate substance may be equal to or greater than the threshold value Rth. However, since the primary differential value dRₜ of the pixel greatly deviates from 0, it is not included in the detection range Rd. Therefore, the pixel in the image region of the approximate substance is not detected as the identification pixel.

In addition, at a pixel in a region other than the target object in the target image (that is, a background region), the reflection spectrum may be in a flat state near 0. At such a pixel, the primary differential value dRₜ is included in the predetermined detection range Rd, but the secondary differential value d²Rₜ is smaller than the threshold value Rth. Therefore, the pixel in the background region is not detected as the identification pixel.

Next, the image generation unit 345 generates the detection image Id by coloring any color for the identification pixel detected in step S5 in the target image or the spectral image Is at the target wavelength λₜ (step S6).

Thereafter, the display control unit 346 outputs the detection image Id generated in step S6 to the display unit 31. Accordingly, the display unit 31 displays the detection image Id (step S7).

Thus, the flowchart of FIG. 2 ends. The user can check the detection image Id displayed on the display unit 31 and determine whether the target object is the target substance based on a coloring ratio of the target object.

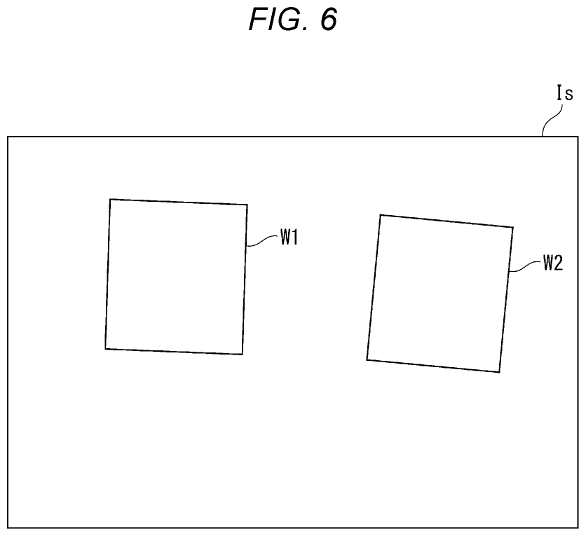

FIG. 6 is a schematic diagram showing one of the spectral images Is in which target objects W1 and W2 are imaged. Here, it is assumed that the target object W1 is made of a target substance and the target object W2 is made of an approximate substance. In the spectral image Is shown in FIG. 6, it is difficult for the user to distinguish the target objects W1 and W2.

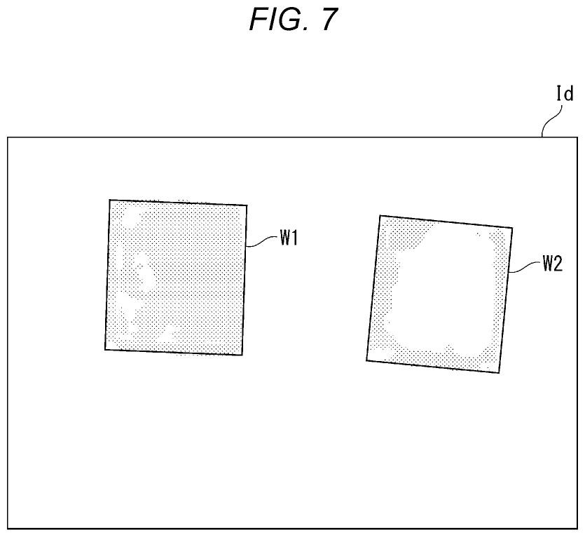

FIG. 7 is a diagram schematically showing the detection image Id generated based on the spectral image Is of the target objects W1 and W2. Here, in an image region of the target object W1 made of the target substance, a colored region is occupied. On the other hand, in an image region of the target object W2 made of the approximate substance, a ratio of the colored region is small. Therefore, in the detection image Id shown in FIG. 7, the user can determine the target object W1 made of the target substance.

### Another Spectral Image Analysis Method

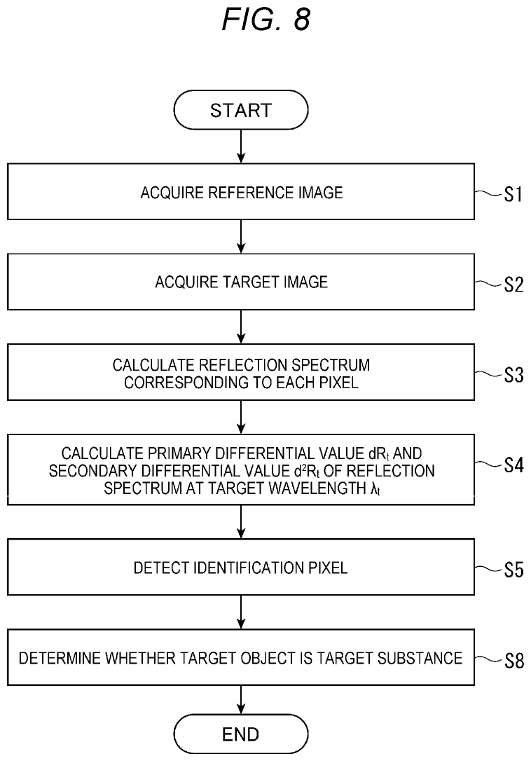

Another example of the spectral image analysis method according to the embodiment will be described with reference to a flowchart of FIG. 8. Here, it is assumed that the target object is made of a single substance.

First, the spectral image analysis system 1 performs the above-described steps S1 to S5.

Thereafter, the determination unit 347 identifies an image region of the target object in the target image using a known image analysis method, and determines whether the target object is the target substance based on whether a ratio of the identification pixels in the image region is equal to or greater than the predetermined threshold value. For example, when the ratio of the identification pixels in the region of the target object is equal to or greater than the predetermined threshold value, the target object is determined to be the target substance (step S8).

Thus, the flowchart of FIG. 8 ends. Thereafter, the spectral image analysis device 3 may output a determination result of step S8 to an external device. Based on the determination result, the external device can perform a sorting process by blowing air to the target substance.

### Operations and Effects of Embodiment

The image analysis method according to the embodiment is an image analysis method to be executed by the processor 34 serving as a computer. The processor 34 functions as the image acquisition unit 341, the spectrum calculation unit 342, the evaluation value calculation unit 343, and the detection unit 344. The image acquisition unit 341 performs a step of acquiring a target image that is an image obtained by imaging a target object and that includes the plurality of spectral images Is corresponding to a plurality of spectral wavelengths different from one another. The spectrum calculation unit 342 performs a step of calculating a reflection spectrum for each pixel based on a light intensity of the pixel of the target image with respect to the spectral wavelength. The evaluation value calculation unit 343 performs a step of calculating the primary differential value dRₜ and the secondary differential value d²Rₜ of the reflection spectrum at a target wavelength, which is a known absorption wavelength of a target substance. The detection unit 344 performs a step of detecting a pixel identified as an image region of the target substance from the target image based on the primary differential value dRₜ and the secondary differential value d²Rₜ.

In such an embodiment, when the target substance is contained in the target image, the secondary differential value d²Rₜ set at a pixel of the image region of the target substance is a sufficiently large value with respect to the secondary differential value d²Rₜ set at a pixel of another region (for example, an image region of another substance having an absorption wavelength completely different from the target wavelength or a background region).

Here, when another substance having an absorption wavelength close to the target wavelength λₜ (hereinafter, referred to as an approximate substance) is contained in the target image, the secondary differential value d²Rₜ set at a pixel of an image region of the approximate substance may be a large value similarly to the secondary differential value d²Rₜ set at the pixel of the image region of the target substance.

Therefore, in the embodiment, not only the secondary differential value d²Rₜ of the spectral spectrum at the target wavelength λₜ but also the primary differential value dRₜ is used to identify the target substance. The primary differential value dRₜ set at the pixel of the image region of the target substance is 0 (or a value near 0 due to an error), whereas the primary differential value dRₜ set at the pixel of the image region of the approximate substance is not a value near 0.

Therefore, according to the embodiment, even when the approximate substance is contained in the target image, the target substance can be detected from the target image while being distinguished from the approximate substance by using the primary differential value dRₜ and the secondary differential value d²Rₜ.

Since the primary differential value dRₜ in the image region of the target substance is 0 regardless of a thickness of the target substance, it is easy to set the detection range Rd for the primary differential value dRₜ. In addition, the threshold value Rth for the secondary differential value d²Rₜ may be a value at which absorption at the target wavelength can be determined, and does not need to be strictly set for each detection range. Accordingly, robustness in detecting the target substance from the target image can be also improved.

In the embodiment, the plurality of spectral wavelengths include the target wavelength λₜ, the forward wavelength λₜ₊ₕ set in front of the target wavelength λₜ, and the backward wavelength λₜ₋ₕ set backward of the target wavelength. Accordingly, the evaluation value calculation unit 343 can easily calculate the primary differential value dRₜ and the secondary differential value d²Rₜ using the numerical differentiation. In addition, since the number of times of imaging of the spectral images Is can be reduced during spectral imaging by the spectral camera 2, a time required for the spectral imaging can be also shortened.

In the embodiment, the processor 34 may function as the image generation unit 345. The image generation unit 345 generates the detection image Id by coloring the identification pixel. Accordingly, the user can recognize the colored image region as the target substance by checking the detection image Id displayed on the display unit 31. In addition, when it is assumed that the target object is made of one kind of substance, the user can determine whether the target object is the target substance based on a ratio of the colored region to the image region of the target object in the detection image Id.

In the embodiment, the processor 34 may function as the determination unit 347. The determination unit 347 determines whether the target object is the target substance based on a ratio of the identification pixels to an arrangement region of the target object in the target image. An external device implemented to be able to communicate with the spectral image analysis device 3 can perform a sorting process or the like for the target substance by using the determination result.

### Modifications

The present disclosure is not limited to the embodiment described above. The present disclosure includes modifications, improvements, and configurations obtained by appropriately combining the embodiments within a scope where an object of the present disclosure can be achieved.

### Modification 1

In the above embodiment, pixels of a target image are set as divided regions of the target image, and the spectrum calculation unit 342 calculates a reflection spectrum for each pixel of the target image, and the present disclosure is not limited thereto. For example, when a region including a plurality of pixels of the target image is set as the divided region, the spectrum calculation unit 342 may calculate a reflection spectrum for the plurality of pixels. In this case, the spectrum calculation unit 342 may calculate the spectral spectrum based on an average of light intensities of the plurality of pixels.

### Modification 2

In the above embodiment, the spectrum calculation unit 342 calculates, as a spectral spectrum, a reflection spectrum indicating a reflectance for each wavelength, and the present disclosure is not limited thereto. For example, the spectrum calculation unit 342 may calculate an absorption spectrum indicating an optical absorptance for each wavelength as the spectral spectrum. In addition, for example, when a light amount of illumination light or imaging sensitivity of the imaging unit 21 is constant with respect to the wavelength, the spectrum calculation unit 342 may calculate the spectral spectrum based on a signal value of each pixel of the plurality of spectral images Is without using a reference image obtained by imaging a reference object.

### Modification 3

In the above embodiment, a plurality of spectral wavelengths include the target wavelength λₜ, the forward wavelength λₜ₊ₕ, and the backward wavelength λₜ₋ₕ, and the present disclosure is not limited thereto. For example, the plurality of spectral wavelengths are not limited to including the target wavelength, and may include a plurality of wavelengths located near the target wavelength. In this case, the evaluation value calculation unit 343 may calculate the primary differential value dRₜ and the secondary differential value d²Rₜ based on a spectral waveform approximately obtained from the spectral spectrum.

### Modification 4

In the image analysis method according to the above embodiment, a step of generating the detection image Id (steps S6 to S7) and a step of determining whether the target object is the target substance (step S8) may be omitted. For example, when the target substance is a foreign substance in the target object, the image analysis device may be implemented to output an alarm in response to detection of an identification pixel from the target image.

### Modification 5

In the image analysis method according to the above embodiment, although the entire acquired captured image is used as an analysis target region, a partial region designated by the user or the like may be used as the analysis target region, and the identification pixel may be detected from within the analysis target region.

### Modification 6

In the above embodiment, an example in which the target object is made of one kind of substance is described, and the target object of the present disclosure is not limited thereto. For example, the target object may be made by mixing a plurality of kinds of substances, or the target object may be made by different substances for each part. Even in such a case, according to the image analysis method in the embodiment, the pixel including the target substance can be detected as the identification pixel.

### Modification 7

In the image analysis device according to the above embodiment, one processor 34 corresponds to the computer of the present disclosure, and the computer of the present disclosure may be implemented by a plurality of processors.

### Summary of Present Disclosure

A spectral image analysis method according to the present disclosure is a spectral image analysis method executed by a computer. The method to be executed by the computer includes: acquiring a target image that is an image obtained by imaging a target object and that includes a plurality of spectral images corresponding to a plurality of spectral wavelengths different from one another; calculating, based on a light intensity of a region of the target image divided for each of the plurality of spectral wavelengths, a spectral spectrum for the divided region; calculating a primary differential value and a secondary differential value of the spectral spectrum at a target wavelength that is a known absorption wavelength of a target substance; and detecting the divided region identified as an image region of the target substance from the target image based on the primary differential value and the secondary differential value.

According to such a method, even when an approximate substance is contained in the target image, the target substance can be detected from the target image while being distinguished from the approximate substance.

In the spectral image analysis method according to the present disclosure, it is preferable that the plurality of spectral wavelengths include the target wavelength, a forward wavelength set in front of the target wavelength, and a backward wavelength set behind the target wavelength.

According to such a method, the primary differential value and the secondary differential value of the spectral spectrum at the target wavelength can be easily calculated. In addition, a time required for spectral imaging can be shortened.

In the spectral image analysis method according to the present disclosure, the computer may further perform a step of generating a detection image by coloring the divided region detected from the target image.

According to such a method, the user can recognize the colored image region as the target substance by checking the detection image.

In the spectral image analysis method according to the present disclosure, the computer may further perform a step of determining whether the target object is the target substance based on a ratio of the divided region detected from the target image to an arrangement region of the target object in the target image.

A spectral image analysis program according to the present disclosure is a program readable and executable by a computer, and causes the computer to perform any one of the spectral image analysis methods described above.

A spectral image analysis device according to the present disclosure includes: an image acquisition unit configured to acquire a target image that is an image obtained by imaging a target object and that includes a plurality of spectral images corresponding to a plurality of spectral wavelengths different from one another; a spectrum calculation unit configured to calculate, based on a light intensity of a region of the target image divided for each of the plurality of spectral wavelengths, a spectral spectrum for the divided region; an evaluation value calculation unit configured to calculate a primary differential value and a secondary differential value of the spectral spectrum at a target wavelength that is a known absorption wavelength of a target substance; and a detection unit configured to detect the divided region identified as an image region of the target substance from the target image based on the primary differential value and the secondary differential value.

According to such a spectral image analysis device, effects same as those of the above-described spectral image analysis method can be achieved.

What is claimed is:

1. A spectral image analysis method to be executed by a computer, the method comprising the computer:
acquiring a target image that is an image obtained by imaging a target object and that includes a plurality of spectral images corresponding to a plurality of spectral wavelengths different from one another;
calculating, based on a light intensity of a region of the target image divided for each of the plurality of spectral wavelengths, a spectral spectrum for the divided region;
calculating a primary differential value and a secondary differential value of the spectral spectrum at a target wavelength that is a known absorption wavelength of a target substance; and
detecting the divided region identified as an image region of the target substance from the target image based on the primary differential value and the secondary differential value.

2. The spectral image analysis method according to claim 1, wherein
the plurality of spectral wavelengths include the target wavelength, a forward wavelength set in front of the target wavelength, and a backward wavelength set behind the target wavelength.

3. The spectral image analysis method according to claim 1, further comprising
the computer generating a detection image by coloring the divided region detected from the target image.

4. The spectral image analysis method according to claim 1, further comprising
the computer determining whether the target object is the target substance based on a ratio of the divided region detected from the target image to an arrangement region of the target object in the target image.

5. A non-transitory computer-readable storage medium storing a spectral image analysis program that is readable and executable by a computer, the program causing the computer to execute:
the spectral image analysis method according to claim 1.

6. A spectral image analysis device comprising:
an image acquisition unit configured to acquire a target image that is an image obtained by imaging a target object and that includes a plurality of spectral images corresponding to a plurality of spectral wavelengths different from one another;
a spectrum calculation unit configured to calculate, based on a light intensity of a region of the target image divided for each of the plurality of spectral wavelengths, a spectral spectrum for the divided region;
an evaluation value calculation unit configured to calculate a primary differential value and a secondary differential value of the spectral spectrum at a target wavelength that is a known absorption wavelength of a target substance; and
a detection unit configured to detect the divided region identified as an image region of the target substance from the target image based on the primary differential value and the secondary differential value.
